(19) United States
(12) Patent Application Publication
(10) Pub. No.: US 2007/0267456 A1
(43) Pub. Date: Nov. 22, 2007

(54) Fixing Appliance with Internal Combustion Engine with Regulating Thermistor

(76) Inventors: Bruno Toulouse, Tain- l'Hermitage (FR); Patrick Herelier, Saint Jean de Muzols (FR); Michel Gleizolles, Saint Marcel les Valence (FR)

Correspondence Address: LOWE, HAUPTMAN, GILMAN & BERNER, LLP (ITW), 1700 DIAGONAL ROAD, SUITE 300, ALEXANDRIA, VA, 22314, US

(21) Appl. No.: 11/569,567

(22) PCT Filed: May 26, 2005
(86) PCT No.: PCT/IB05/01452

§ 371 Date: Nov. 22, 2006

(30) Foreign Application Priority Data
May 27, 2004 (FR) 0405714

(51) Int. Cl. B25C 1/08

(52) U.S. Cl. 227/9

(57) ABSTRACT

The appliance comprises a piston mounted in a cylinder of an internal combustion engine and forming, with a cylinder head, a combustion chamber in which there is disposed a mixing, emptying and cooling fan associated with an electric drive motor (8) connected to an electronic management module and to a supply battery. It also comprises, close to the fan motor (8), a thermistor (12) sensitive to the temperature provided for transmitting the temperature information to the management module.

The invention concerns fixing appliances with driving of fixing elements by a piston propelled in a cylinder of an internal combustion engine, forming, with a cylinder head, a combustion chamber in which there is disposed a mixing, emptying and cooling fan. This is because the fan serves first of all to obtain the flammable mixture of gas and air; it also serves to empty the combustion chamber of the combustion residues; finally, the fan also serves to cool all the components which may have heated up during ignition and, in particular, the cylinder, the piston, the cylinder head and the other components constituting the combustion chamber.

Today, the sum of the emptying and cooling periods, after ignition, during which the fan continues to be driven in rotation, is determined as soon as the appliance is designed and fixed in the factory. This is regrettable.

The thermal realities are not taken into account.

The ideal would be to dispose a temperature sensor on the cylinder. This design would be expensive and in any event difficult to implement. As for the solution of providing a sensor on another component of the engine, this also would not be easy to implement.

Wishing then to improve the cooling conditions of the fixing appliances introduced above, the applicant had the idea of wishing to profit from the fact that the fan motor is connected to an electronic management module and to the battery supplying the appliances and thus it proposes its invention.

The invention therefore concerns a fixing appliance with driving of fixing elements by a piston mounted in a cylinder of an internal combustion engine and forming, with a cylinder head, a combustion chamber in which a mixing, emptying and cooling fan is disposed, associated with an electric drive motor connected to an electronic management module and to a supply battery, an appliance characterised by the fact that it comprises, close to the fan motor, a thermistor sensitive to the temperature provided for transmitting the temperature information to the management module.

The management module, which, advantageously, comprises a processor, manages the temperature information supplied by the thermistor in order to determine the period of functioning of the fan after ignition according to this temperature, for example by means of a ventilation and temperature duration table.

In the preferred embodiment of the appliance of the invention, the fan motor is connected to the management module by a connecting circuit and the thermistor is mounted on this connecting circuit, in principle a printed circuit.

This solution is easy to implement since it suffices, apart from the installation of the thermistor, to provide an additional terminal on the connector of the connecting circuit for transmitting the temperature information.

The invention will be better understood by means of the following description of the preferred embodiment of the appliance of the invention, with reference to the accompanying drawing, in which

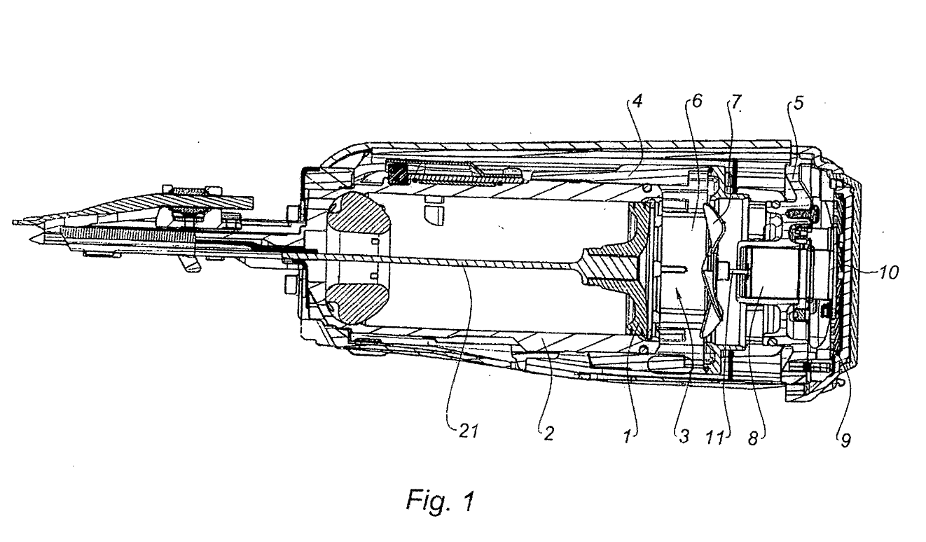

FIG. 1 is a view in longitudinal section of the appliance;

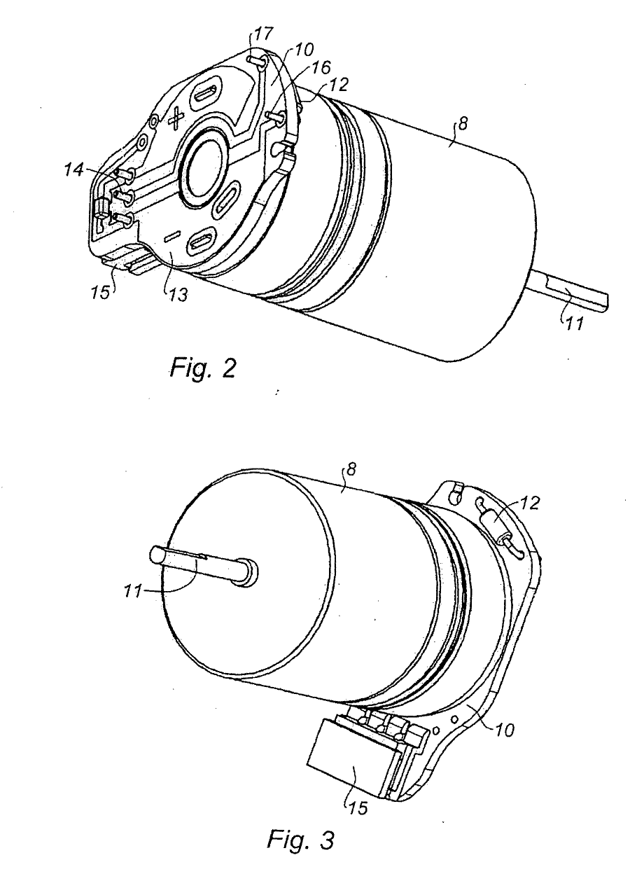

FIG. 2 is a rear perspective view of the fan motor of the appliance of FIG. 1, showing the printed circuit connecting the motor to the electronic management module of the appliance, and

FIG. 3 is a front perspective view of the motor of FIG. 2, showing the thermistor mounted on the printed circuit.

The appliance which will now be described, for all that conventional in almost all its elements, is an appliance intended to drive fixing elements by means of a piston 1, to which there is fixed a propulsion rod 21, the piston 1 being mounted in a cylinder 2 of an internal combustion engine 3, the cylinder 2 forming, with a sleeve 4, in which it is slidably mounted, and a cylinder head 5, a combustion chamber 6. A fan 7 is disposed in the chamber 6 in order to fulfil a mixing function and obtain a good flammable mixture, an emptying function for emptying the combustion chamber of the combustion residues and also a function of cooling the components which have heated up during the ignition.

The fan 7, in a manner known per se, is rotated by a motor 8, on the shaft 11 of which it is mounted, the motor being mounted in the cylinder head 5 and being connected to an electronic management module 9 and to the electrical supply battery (not shown) by a printed circuit 10.

On the side of the printed circuit here turned towards the front there is mounted a regulating thermistor 10 whose lugs 16, 17 are respectively connected to an earthing area 13 of the printed circuit and to a terminal 14 of a connector 15 for connection to the management module 9, therefore providing the connection of the thermistor 12 and management module 9. In this way, and a processor (not shown) being installed in the management module 9, the temperature information supplied by the thermistor 12 can be processed in order to determine the correct duration of functioning of the fan 7 after ignition.

1-5. (canceled)

6. Gas-operated fixing device comprising an internal combustion engine for driving fasteners arranged in a casing fitted in a handle and fixed to it at the rear, characterized in that the front of the case is fitted floating in the handle so as to be able to slide in it along the drive axis of the fasteners.

7. Fixing device according to claim 6, whereby the front of the case is fitted for sliding in the handle forward up to front means of stopping.

8. Fixing device according to claim 6, whereby the front of the case is fitted for sliding in the handle rearward up to rear means of stopping.

9. Fixing device according to claims 6, whereby the case and the handle of the device are fixed to each other by tenon and slot assemblies.

10. Fixing device according to claim 9, whereby the tenons and the slots are oblong in shape, the tenons being shorter than the slots at the front of the case.
